(19) United States
(12) Patent Application Publication
(10) Pub. No.: US 2002/0100739 A1
(43) Pub. Date: Aug. 1, 2002

(54) Storage unit

(75) Inventors: Paul Francis Day, Surrey (GB); Jeffrey Leonard Coulling, Ashford (GB)

Correspondence Address: WOOD, HERRON & EVANS, L.L.P., 2700 Carew Tower, 441 Vine St., Cincinnati, OH, 45202, US

(73) Assignee: Advanced Biotechnologies Limited

(21) Appl. No.: 09/985,626

(22) Filed: Nov. 5, 2001

(30) Foreign Application Priority Data
Nov. 8, 2000 (GB) GB0027272.4

(51) Int. Cl. A47F 3/14; A47J 47/00; B65D 1/34; B65D 6/04

(52) U.S. Cl. 211/126.2; 206/557

(57) ABSTRACT

A storage unit assembly comprising:

(i) a plurality of trays, each tray having a floor and three side walls, a fourth side of each tray being substantially open such that items may be inserted into the tray from that side, the trays being adapted to stack one on top of each other;

(ii) A plurality of retaining stud assemblies, each assembly comprising a retaining stud with a fixing means at each end, the retaining studs being adapted to pass through apertures in the perimeter of each tray and further adapted to fasten a stack of trays together; and

(iii) handle means to enable the storage unit assembly to be picked up and transported.

### FIELD OF THE INVENTION

The present invention relates to storage units. It is particularly applicable, but in no way limited, to storage units for holding a plurality of multi-well storage plates.

### BACKGROUND TO THE INVENTION

Multi-well plates, or two-dimensionally bound arrays of wells or reaction chambers, are commonly employed in research and clinical procedures for the storage, screening and evaluation of multiple samples. Multi-well plates are especially useful in conjunction with automated thermal cyclers for performing the widely used polymerase chain reaction, or “PCR”, and for DNA cycle sequencing and the like. They are also highly useful for biological micro-culturing and assay procedures, and for performing chemical syntheses on a micro scale. However, these are only some of the uses that multi-well plates can be put to.

Multi-well plates for PCR use are typically comprised of a plurality of plastic tubes arranged in rectangular planar arrays of typically 3×8 (a 24 well plate), 6×8 (a 48 well plate) or 8×12 (a 96 well plate) tubes with an industry standard 9 mm (0.35 in.) centre-to-centre tube spacing (or fractions thereof). As technology has advanced plates with a larger number of wells have been developed such as 16×24 (a 384 well plate). Examples of this type of consumable plastic product together with micro titre and deep well plates are sold by Advanced Biotechnologies Limited of Abgene House, Blenheim Road, Epsom, Surrey, United Kingdom.

It is often necessary to store such plates between operations or after reactions have taken place and before the results can be analysed. Sometimes it is necessary to store hundreds or even thousands of these plates for a period of time. They may also need to be refrigerated or frozen during storage. The plates can be simply stacked one on top of each other but that is not very satisfactory. The stacks are not very stable and cannot easily be transported from place to place without risk of spillage. A more elegant solution is to put the individual plates into racks where each plate is stored on its own shelf, one above another. Racks suitable for this purpose are commercially available. They are typically made from metal such as stainless steel or aluminium and they are, in effect, a series of equally spaced metal shelves in a rigid metal frame. These known racks suffer from a number of disadvantages. Firstly, because of their construction they tend to be relatively expensive. Since many tens or hundreds of racks are needed then cost is an important consideration. Secondly, because of their rigid constructions they are inevitably of fixed height/capacity and the distance between each shelf is fixed. They may not, therefore, fit into the various types of storage space available in a space-efficient manner. For example, if they are designed to fill a shelf space completely they may be too tall or too short to fit into a chest freezer economically.

It is an objective of the present invention to overcome or mitigate some or all of the disadvantages outlined above.

### SUMMARY OF THE INVENTION

According to the present invention there is provided a storage unit assembly comprising:

(i) a plurality of trays, each tray having a floor and three side walls, a fourth side of each tray being substantially open such that items may be inserted into the tray from that side, the trays being adapted to stack one on top of each other;

(ii) a plurality of retaining stud assemblies, each assembly comprising a retaining stud with a fixing means at each end, the retaining studs being adapted to pass through apertures in the perimeter of each tray and further adapted to fasten a stack of trays together; and

(iii) handle means to enable the storage unit assembly to be picked up and transported.

By providing a plurality of trays and retaining stud assemblies of different lengths, storage units of different heights can be constructed to meet specific storage requirements.

Preferably the assembly further comprises a top plate adapted to substantially cover the uppermost tray in the stack and preferably the assembly further comprises a bottom plate adapted to fit under the lower most tray in the stack. These plates increase the rigidity of the assembled unit.

Preferably a handle means is incorporated into the top plate.

In a particularly preferred embodiment the assembly incorporates a handle means on both the top and along one side of the stack.

Preferably the handle means is rotatably mounted with respect to the stack such that, when not in use, the handle means folds flat against the stack.

Preferably the assembly further comprises a locking rod adapted to pass down the stack through apertures adjacent to the open side of each tray to prevent items on a tray inadvertently slipping out.

Preferably the assembly further comprises a plurality of feet on the bottom of the stack, said feet being adapted to nest with the top of the retaining stud assemblies on a further assembly such that the storage unit assemblies stack one on top of another.

In a further preferred embodiment the assembly further comprises spacers adapted to fit over the retaining studs and to space the trays apart such that they no longer nest directly together to allow items which are taller than the height of the tray side walls to be accommodated in the storage unit.

Preferably retaining stud assemblies of different heights are provided such that stacks of different heights can be secured together to give storage unit assemblies of different height to suit different storage requirements.

Preferably the trays are adapted to nest one on top of another, the top of one tray being adapted to positively engage with the underside of the tray above it in the stack.

The invention also provides for a storage unit assembly comprising:

(i) a plurality of trays adapted to stack one on top of another;

(ii) a plurality of retaining stud assemblies adapted to fasten a stack of trays together;

wherein the trays are adapted to nest together in a stack, with the top of one tray being adapted to positively engage with the underside of the tray above it in the stack.

Preferably the trays comprise a floor and three side walls, a fourth side of the tray being substantially open.

In a particularly preferred embodiment notches are provided in the bottom of each tray, said notches corresponding to protrusions on the top of the trays, said notches and protrusions providing a positive engagement when trays are stacked one on top of another.

According to a further aspect of the invention there is provided a storage unit assembly adapted to accommodate multi-well plates, said storage unit assembly comprising:

(i) a plurality of trays adapted to accommodate multi-well plates; and

(ii) at least one retaining stud assembly adapted to fasten a stack of trays together.

Preferably each retaining stud assembly comprises a retaining stud with a fixing means at each end, the retaining studs being adapted to pass through apertures in the perimeter of each tray.

Preferably the assembly further comprises a handle means to enable the storage unit assembly to be picked up and transported.

In a further preferred embodiment the storage unit assembly further optionally comprises one or more of the following:

(iii) a top plate adapted to substantially cover the uppermost tray in the stack;

(iv) a bottom plate adapted to fit under the lower most tray in the stack;

(v) a locking rod adapted to retain items in the trays and to prevent them slipping out;

(vi) a plurality of feet;

(vii) spacers adapted to fit over the retaining stud assembly and adapted to space the trays apart to allow items which are taller than the height of the trays to be accommodated in the storage unit.

The invention is intended to include a kit of parts for constructing one or more storage unit assemblies as described herein.

This includes a kit for a storage unit assembly adapted to accommodate multi-well plates, said kit comprising:

(i) at least two trays adapted to accommodate multi-well plates;

(ii) at least one retaining stud assembly adapted to pass through apertures in the perimeter of each tray and further adapted to fasten a stack of trays together.

Such a fit further optionally comprises one or more of the following:

(iii) handle means to enable the storage unit assembly to be picked up and transported;

(iv) a top plate adapted to substantially cover the uppermost tray in the stack;

(v) a bottom plate adapted to fit under the lower most tray in the stack;

(vi) a locking rod adapted to retain items in the trays and to prevent them slipping out;

(vii) a plurality of feet;

(viii) spacers adapted to fit over the retaining stud assembly and adapted to space the trays apart to allow items which are taller than the height of the trays to be accommodated in the storage unit.

### DESCRIPTION OF THE DRAWINGS

The invention will further be described, by way of example only, with reference to the accompanying drawings in which:

FIG. 1 illustrates a side elevation of an assembled storage unit assembly according to the present invention;

FIG. 2 illustrates a front elevation of the storage unit assembly shown in FIG. 1;

FIG. 3 illustrates various views of a tray of the type used in the storage unit assembly of FIGS. 1 and 2;

FIGS. 4A and 4B show a plan and side elevation respectively of a top plate;

FIGS. 5A and 5B illustrate a plan and side elevation respectively of a bottom plate;

FIG. 6 shows a retaining stud assembly;

FIG. 7 shows a locking rod;

FIG. 8 shows a universal handle;

FIG. 9 shows a plan view from the top of the storage unit assembly of FIG. 2;

FIG. 10 shows a top handle;

FIG. 11 shows a handle tang;

FIG. 12 shows a side and plan elevation of a foot;

FIG. 13 shows side and plan elevations of a washer for the top plate; and

FIGS. 14A and 14B show plan and side elevations respectively of a handle link.

FIGS. 15 and 16 illustrate side and front elevations respectively of a second embodiment of the present invention;

FIGS. 17 and 18 illustrate front and side views of an alternative retaining stud or rod;

FIGS. 19 and 19A illustrate side and end views of a universal handle;

FIGS. 20A and 20B illustrate a spacer;

FIGS. 21A and 21B illustrate cross-sectional and end views respectively of a foot.

### DESCRIPTION OF THE PREFERRED EMBODIMENTS

Embodiments of the present invention are described below by way of example only. These examples represent the best ways of putting the invention into practice that are currently known to the applicant although they are not the only ways in which this could be achieved.

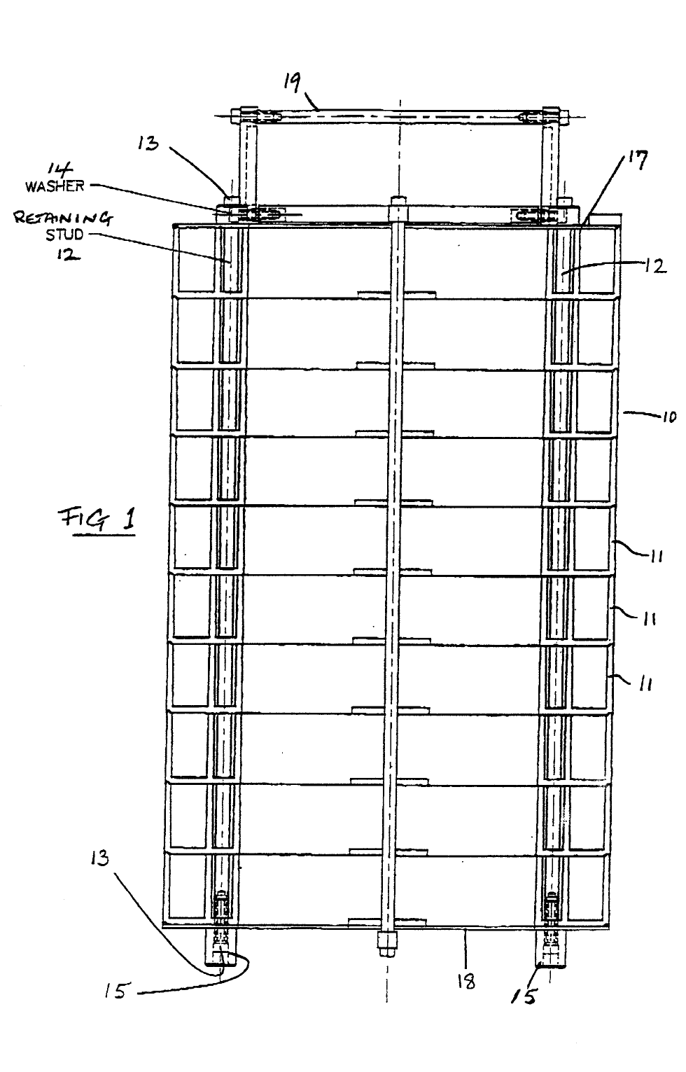

Referring to FIGS. 1 and 2, these show a storage unit assembly 10 according to the present invention in an assembled form. The assembly consists of a series of trays 11 designed to stack one on top of each other in a nesting arrangement. The stack is held together by four retaining rod assemblies one at each corner of the stack. These retaining rod assemblies consist of a retaining stud or rod 12 with a cap screw 13 at each end. The load is spread by a washer 14 at the top of the stack and by a foot 15 at the base of the stack. The foot is designed with an indentation in its bottom surface which will accommodate the top of a cap screw 13. This feature enables the storage unit assemblies to stack one on top of another in a stable manner.

The retaining stud or rod 12, cap screws 13, washer 14 and foot 15 together make up a retaining rod assembly.

The trays are advantageously formed from plastics material such as polyethylene or polypropylene which makes them light and relatively inexpensive. The assembly can be made more rigid by including a top plate 17 and a bottom plate 18. These plates are preferably formed from sheet metal material such as stainless steel. The top plate includes a handle means. The handle means is formed from the components shown in FIGS. 10 and 14. In effect, two parallel rods 20 are spaced apart by handle links 21 and retained by cap screws 13. A housing attached or integral to the top plate accommodates one of the rods. The handle means is thus pivotally mounted with respect to the top of the storage unit. The profile of the handle in its stowed away or folded flat configuration is less than the height of the washers. Thus the handle does not interfere with the stacking arrangement described above. This top handle is useful for removing the storage unit assembly from a chest freezer and for carrying it around.

Advantageously, further handles can be provided on the sides of the units to enable them to be withdrawn easily from shelves or the like. Such a handle is shown as 22 in FIG. 2. These handles can be formed from two retaining studs 12 in parallel, non-coaxial corresponding end alignment and joined by handle links 21 at each end. One of the retaining studs is threaded through specially provided apertures in the edge of the trays. This arrangement is shown more clearly in FIGS. 2 and 9.

It is not necessary for the handle on the side to extend the full height of the stack. A shorter handle can be formed in the same manner as described above by threading a retaining stud through only some of the trays.

A further feature of this storage unit is a locking rod 26. This is formed from stainless rod bent over at one end. In use, the rod passes through indentations or apertures in the front edge of each tray and through apertures in the top and bottom plates. The downward depending portion 27 slots through an aperture in the top plate to hold the locking rod in place. By using indentations rather than discrete holes in the front edge of each tray the locking rod is easy to insert and remove. It only has to be threaded through apertures in the top and bottom plates. If a more secure locking means is required then the locking rod may pass through discrete apertures in the front of each tray. This type of arrangement is illustrated in FIG. 16.

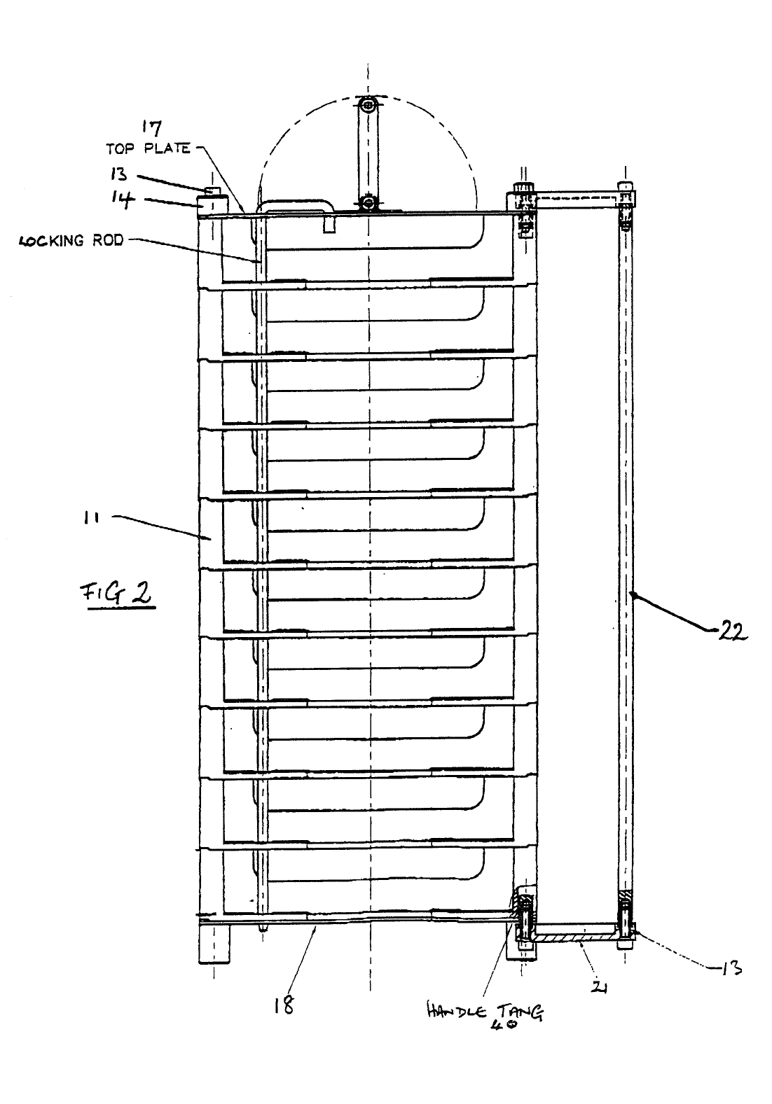

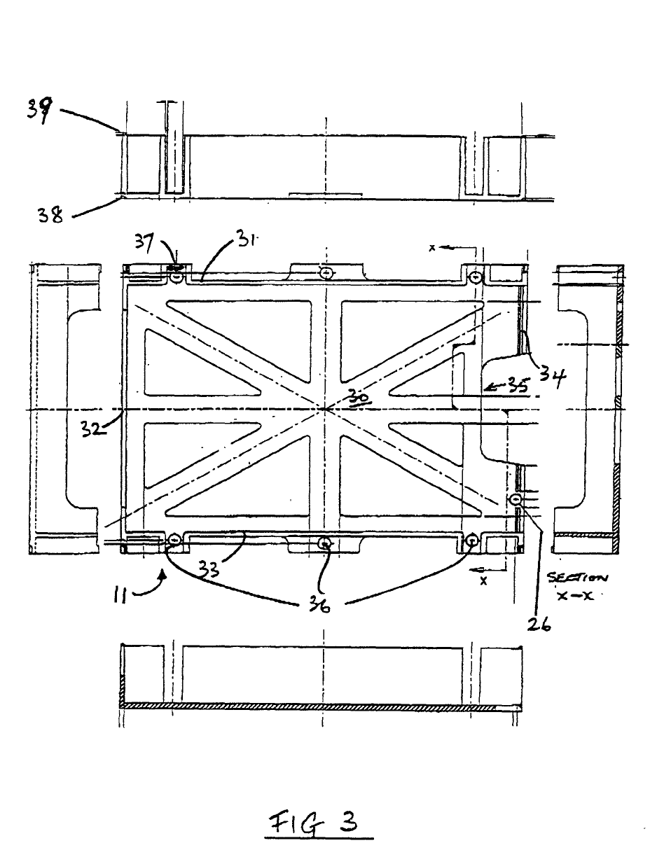

The trays 11 used in this invention are illustrated in FIG. 3. They consist of a base or floor 30 and three sidewalls 31, 32 and 33. The sidewalls are substantially perpendicular to the floor of the tray and form three sides of a rectangle. The fourth side has no sidewall as such but has a small lip 34 to prevent plates sliding out accidentally. To make the plates easier to remove an indented region 35 is provided at the open edge of each tray. Holes 36 are formed at strategic points around the perimeter of the tray to accommodate retaining studs and handles. To keep weight and costs to a minimum, the floor of the plate is not solid but formed from various cross-members. The arrangement of cross-members shown in FIG. 3 is just one of many arrangements which could be used.

Nestable stacks of trays are formed by having small notches 38 in the bottom corners of each tray and corresponding protrusions 39 in the top corners of each tray. This gives the nested stacks of trays a certain inherent rigidity and stability.

The size, shape and configuration of the trays may be designed to accommodate certain specific items such as standard 96 well PCR plates. Where deeper plates have to be accommodated then spacers 150 are simply inserted over the retaining studs to increase the effective depth of each tray. These spacers can be formed from uniform lengths of stainless steel tube with an internal diameter slightly larger than that of the retaining stud and with an external diameter which will fit into recesses 37. This is an important feature because it enables a storage rack assembly to be modified quite easily to accommodate a wide range of plates of different heights. Thus relatively shallow 384 well PCR plates and 96 deep well plates can be accommodated equally easily in a space efficient manner.

Advantageously, the trays can be colour coded to indicate different experiments, different experimenters or different dates of experiment. Thus, all experiments carried out during a particular week could be stored in racks made up of red trays. The ability to build storage units of different heights, different shelf depths and in different colours is not available in the prior art products.

It is envisaged that a kit of parts will be supplied containing a plurality of trays together with a range of handles and retaining studs of various lengths. Alternatively, the experimenter can specify the height of stack required and the component parts will be supplied accordingly. It will be appreciated that if the experimenter wishes to vary the height of an existing storage unit assembly then this can easily be done by removing the existing retaining studs, adding or subtracting trays from the stack and inserting retaining studs of the new length.

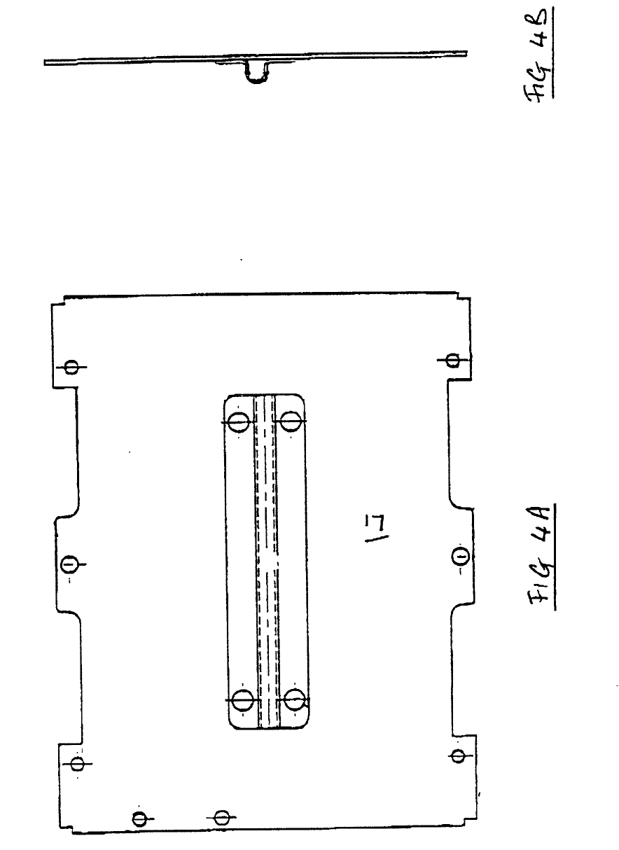

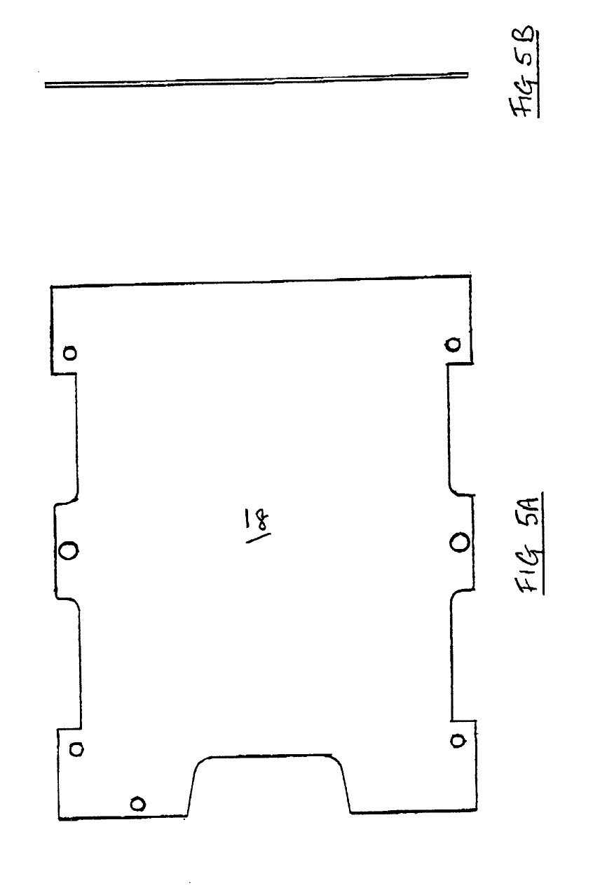

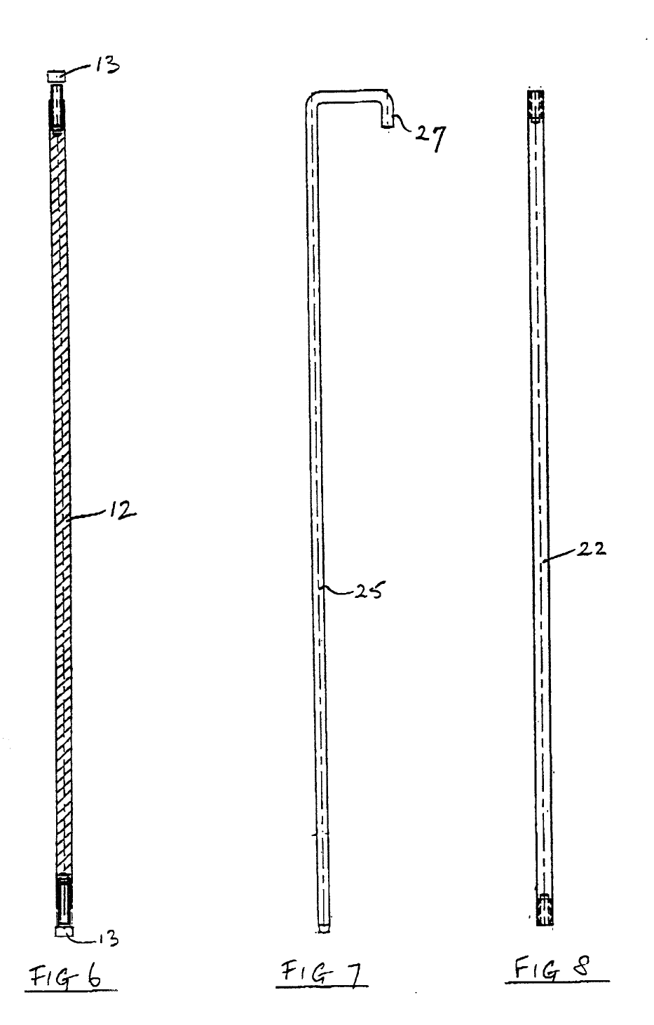

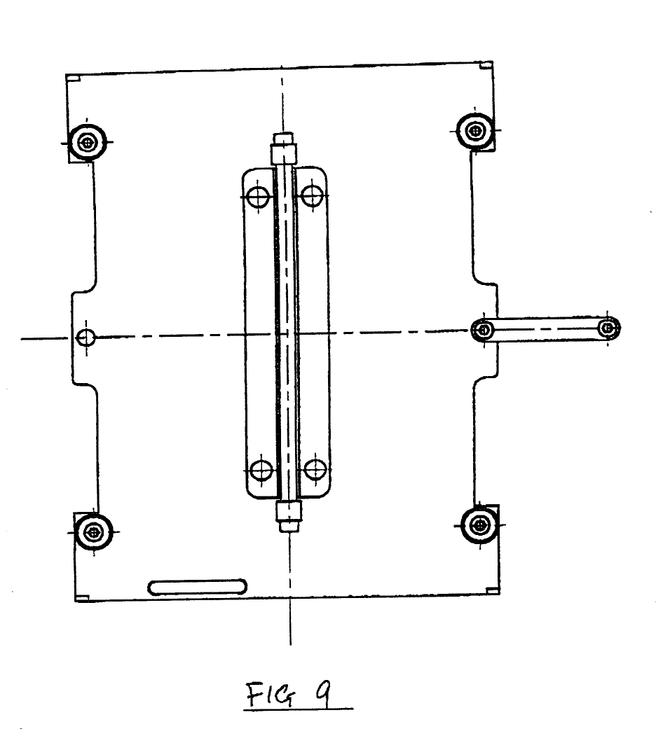

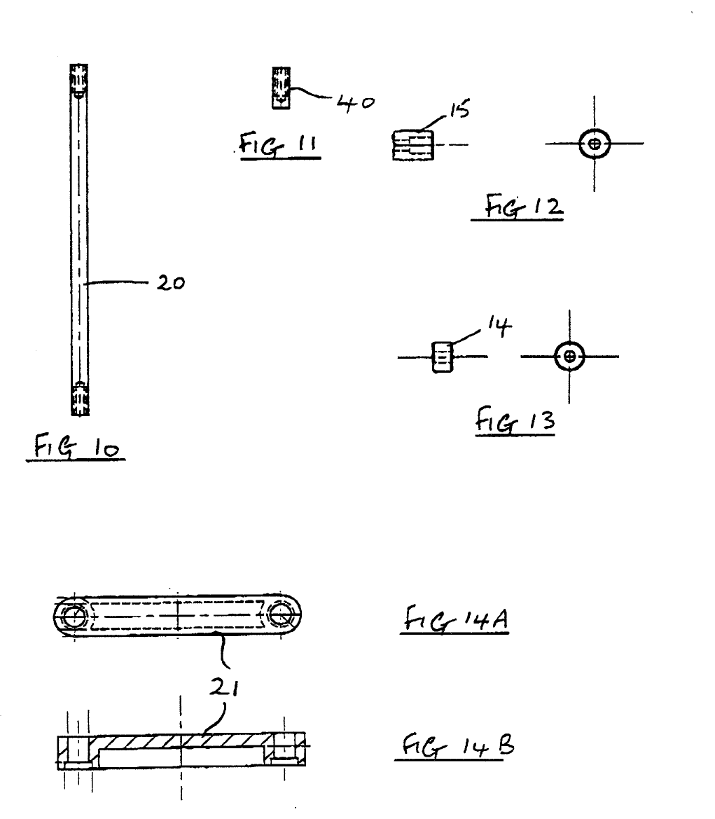

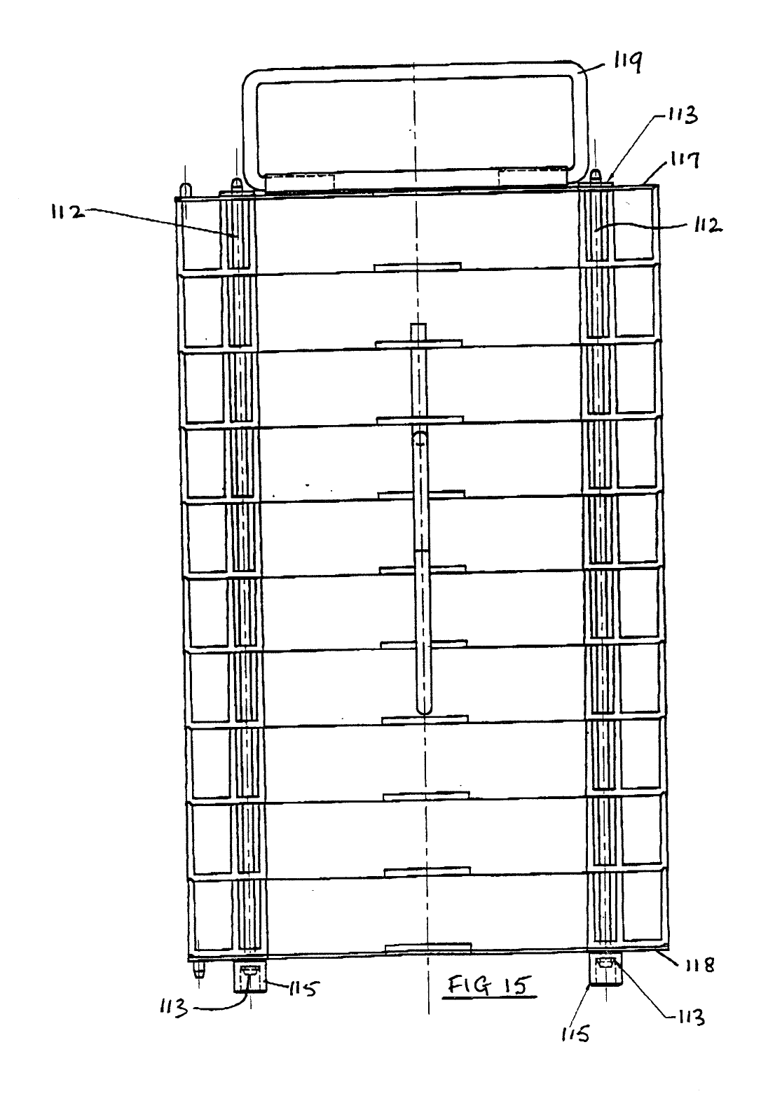

A storage unit assembly according to a second embodiment of the present invention is illustrated in FIGS. 13 to 21 inclusive. A numbering system corresponding to that used in FIGS. 1 to 14 has been used in the later Figures. FIGS. 15 and 16 illustrate side and front elevations respectively of a complete storage unit assembly. It consists of a nested stack of trays 111 held together by four retaining rods or studs 112. The major differences in this assembly relate to the retaining means at the end of the retaining rods, the feet and the handles.

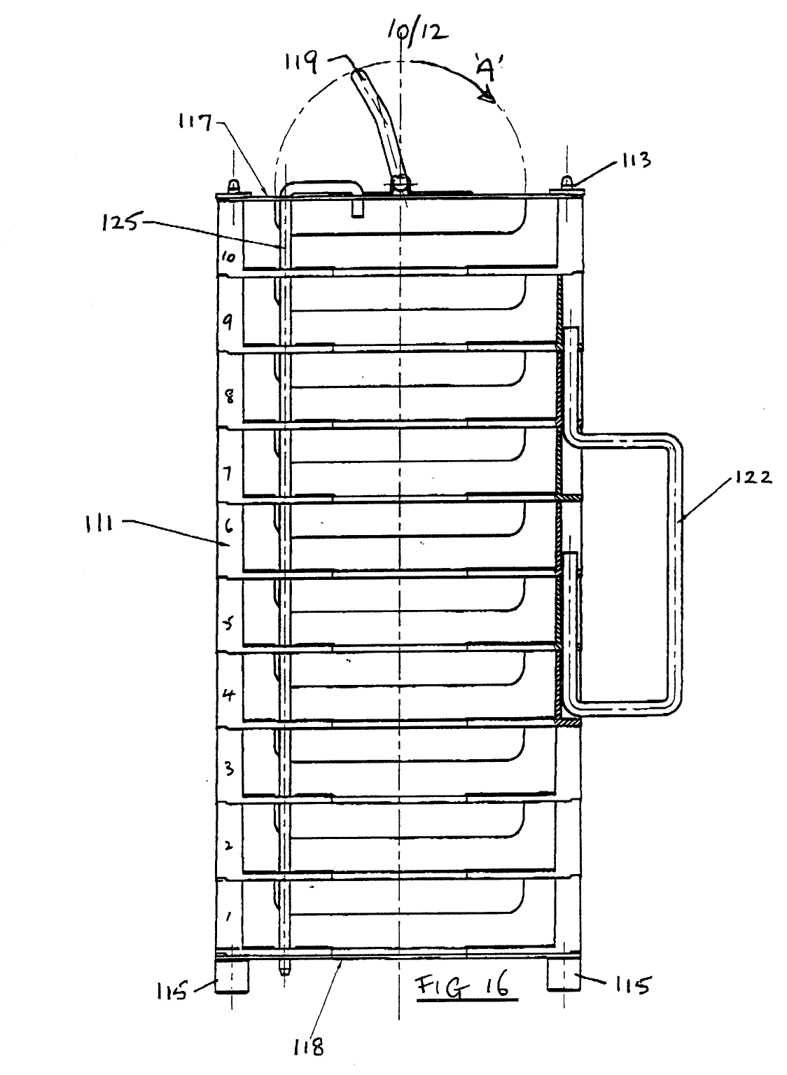

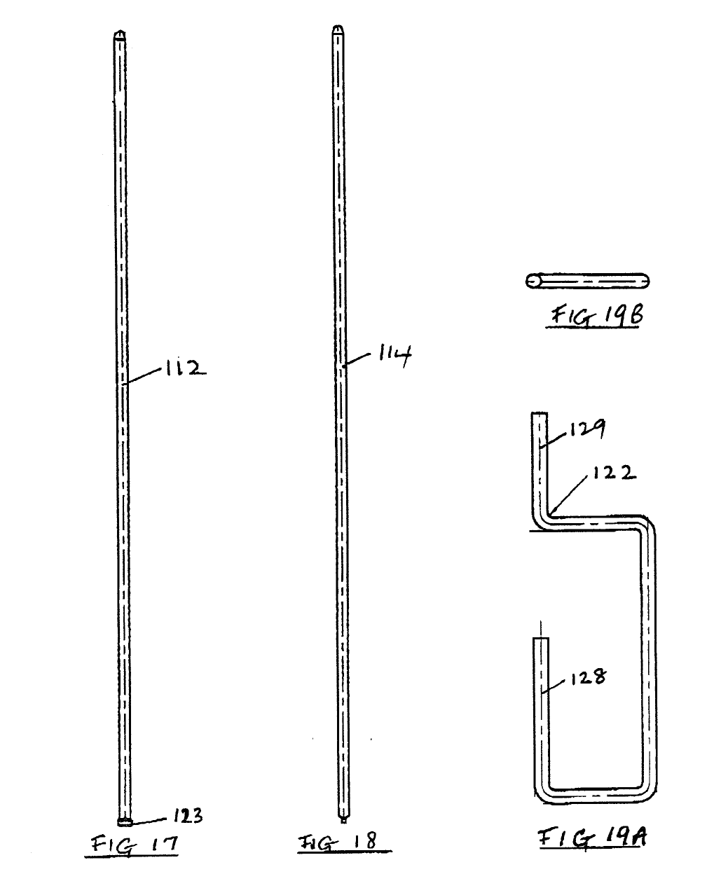

In this embodiment the screw end caps to the rods have been dispensed with. Instead, one end of the rod 112 is formed into a head, 123, which is larger in diameter than the holes through the trays or through the bottom plate 117. Thus there is no need for any supplementary fixing at the bottom of the retaining stud assembly. The head 123 is formed by crimping the end of the rod to form a flattened region where the width of metal is larger than the diameter of the holes in the trays or in the top and bottom plates. This arrangement is shown in FIGS. 17 and 18.

A different type of proprietary fixing is used at the top of the assembly to that illustrated in FIG. 6. An end cap 113 with a wide, spreading flange and an internal non-return spring grip or clip is used. Once forced over the end of the rod, teeth on the inside of the spring engage with the outer perimeter of the rod and prevent the assembly from coming apart. To increase the grip of the spring clip on the metal rod, a series of circumferential grooves (not shown) can be formed in the end region of the outside of the rod. The grooves need not be very deep, just deep enough for the edge of the spring to engage into. This arrangement provides for a much more secure form of fixing and prevents the assembly coming apart accidentally if the storage rack is dropped or shaken.

A universal handle 122 has been designed which can be used with any height of stack. During assembly, and referring to FIG. 16, as the stack is built up, trays 5 and 6 are threaded over the upwardly extending portion 128 of the handle. Trays 8 and 9 are similarly threaded over the extending portion 129. The handle 122 is thus held firmly by the trays in the stack and will take the weight of the stack but is free to rotate through 180°. The handle 119 mounted to the top plate 117 is non-linear when viewed from the side. This means that when rotated in the direction of arrow ‘A’ the edge of the handle rests proud above the top plate and is easier to take hold of.

Small hollow feet 142 are provided. The hollow recessed region 144 is large enough to accommodate the head 123 of the retaining rod and this head bears on a washer 143. The diameter in the narrow region of the foot 145 is a passing fit around the retaining stud. The hollow region of the foot 144 is adapted to accommodate the retaining cap 113 and thus these storage assemblies are adapted to stack stably one on top of another.

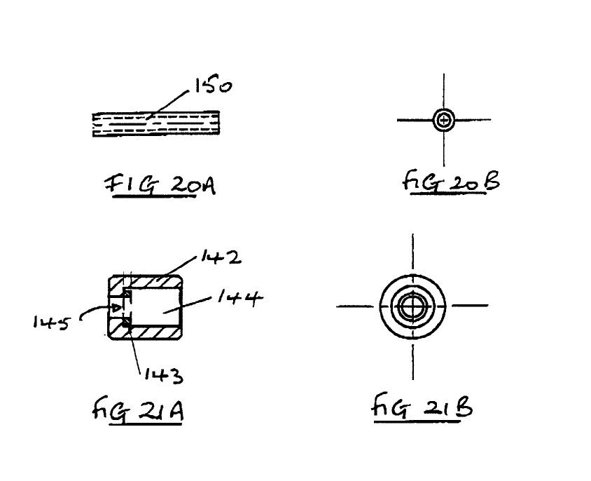

FIG. 20 illustrates a spacer 150 which can be threaded over the retaining rods to allow the trays to be separated from each other and distanced apart. This allows a wide range of multi-well plate depths to be accommodated the trays.

There are a wide range of constructions which allow the trays to nest together and only one has been shown here. For example, a ridge could run the full length of each topside of the tray and engage in a channel running the full length of the corresponding bottom on the tray above. The preferred arrangement would be decided by a mouldings expert. It will be appreciated that while some form of nesting arrangement is advantageous, the trays could simply stack one on top of each other. In this case, alignment is achieved by threading the retaining studs through the holes provided in the perimeter of the tray.

The various components for a storage unit assembly will be constructed from materials as selected by a materials specialist. The metal components are typically formed from stainless steel or aluminium and the trays are formed from a plastics material which is not affected by common laboratory solvents.

The trays, and thus the storage unit assembly are specifically adapted to accommodate multi-well plates, especially PCR plates. This adaptation is achieved through the size and depth of the trays, and particularly the footprint of the internal base or floor of each tray. Multi-well plates, which are of standard footprints, can thus be accommodated snugly within each tray. The depth between adjacent trays can be adjusted as necessary using spacers 150 of different lengths.

1. A storage unit assembly comprising:
(i) a plurality of trays, each tray having a floor and three side walls, a fourth side of each tray being substantially open such that items may be inserted into the tray from that side, the trays being adapted to stack one on top of each other;
(ii) a plurality of retaining stud assemblies, each assembly comprising a retaining stud with a fixing means at each end, the retaining studs being adapted to pass through apertures in the perimeter of each tray and further adapted to fasten a stack of trays together; and
(iii) handle means to enable the storage unit assembly to be picked up and transported.

2. A storage unit assembly as claimed in claim 1 wherein the assembly further comprises a top plate adapted to substantially cover the uppermost tray in the stack.

3. A storage unit assembly as claimed in claim 2 wherein a handle means is incorporated into the top plate.

4. A storage unit assembly as claimed in claim 1 wherein the assembly further comprises a bottom plate adapted to fit under the lower most tray in the stack.

5. A storage unit assembly as claimed in claim 1 wherein the assembly incorporates a handle means on both the top and along one side of the stack.

6. A storage unit assembly as claimed in claim 1 or claim 5 wherein the handle means is rotatably mounted with respect to the stack such that, when not in use, the handle means folds flat against the stack.

7. A storage unit assembly as claimed in claim 1 wherein the assembly further comprises a locking rod adapted to pass down the stack through an aperture adjacent to the open side of each tray to prevent items on a tray inadvertently slipping out.

8. A storage unit assembly as claimed in claim 1 wherein the assembly further comprises a plurality of feet on the bottom of the stack, said feet being adapted to nest with the top of the retaining stud assemblies such that the storage unit assemblies stack one on top of another.

9. A storage unit assembly as claimed in claim 1 wherein the assembly further comprises spacers adapted to fit over the retaining studs and to space the trays apart such that they no longer nest directly together to allow items which are taller than the height of the tray side walls to be accommodated in the storage unit.

10. A storage unit assembly as claimed in claim 9 wherein retaining stud assemblies of different heights are provided such that stacks of different heights can be secured together to give storage unit assemblies of different height to suit different storage requirements.

11. A storage unit as claimed in claim 1 wherein the trays are adapted to nest one on top of another, the top of one tray being adapted to positively engage with the underside of the tray above it in the stack.

12. A storage unit assembly comprising:
(i) a plurality of trays adapted to stack one on top of another;
(ii) a plurality of retaining stud assemblies adapted to fasten a stack of trays together;
wherein the trays are adapted to nest together in a stack, with the top of one tray being adapted to positively engage with the underside of the tray above it in the stack.

13. A storage unit assembly as claimed in claim 12 wherein the trays comprise a floor and three side walls, a fourth side of the tray being substantially open.

14. A storage unit assembly as claimed in claim 12 wherein notches are provided in the bottom of each tray, said notches corresponding to protrusions on the top of the trays, said notches and protrusions providing a positive engagement when trays are stacked one on top of another.

15. A storage unit assembly adapted to accommodate multi-well plates, said storage unit assembly comprising:
(i) a plurality of trays adapted to accommodate multi-well plates; and
(ii) at least one retaining stud assembly adapted to fasten a stack of trays together.

16. A storage unit assembly as claimed in claim 15 wherein each retaining stud assembly comprises a retaining stud with a fixing means at each end, the retaining studs being adapted to pass through apertures in the perimeter of each tray.

17. A storage unit assembly as claimed in claim 15 wherein the assembly further comprises a handle means to enable the storage unit assembly to be picked up and transported.

18. A storage unit assembly as claimed in claim 15 which further optionally comprises one or more of the following:
(iii) a top plate adapted to substantially cover the uppermost tray in the stack;
(iv) a bottom plate adapted to fit under the lower most tray in the stack;
(v) a locking rod adapted to retain items in the trays and to prevent them slipping out;
(vi) a plurality of feet;
(vii) spacers adapted to fit over the retaining stud assembly and adapted to space the trays apart to allow items which are taller than the height of the trays to be accommodated in the storage unit.

19. A kit for a storage unit assembly adapted to accommodate multi-well plates, said kit comprising:
(i) at least two trays adapted to accommodate multi-well plates;
(ii) at least one retaining stud assembly adapted to pass through apertures in the perimeter of each tray and further adapted to fasten a stack of trays together.

20. A kit for a storage unit assembly as claimed in claim 19 and which further optionally comprises one or more of the following:
(iii) handle means to enable the storage unit assembly to be picked up and transported;
(iv) a top plate adapted to substantially cover the uppermost tray in the stack;
(v) a bottom plate adapted to fit under the lower most tray in the stack;
(vi) a locking rod adapted to retain items in the trays and to prevent them slipping out;
(vii) a plurality of feet;
(viii) spacers adapted to fit over the retaining stud assembly and adapted to space the trays apart to allow items which are taller than the height of the trays to be accommodated in the storage unit.
